(19) United States
(12) Patent Application Publication
(10) Pub. No.: US 2020/0374471 A1
(43) Pub. Date: Nov. 26, 2020

(54) PTZ VIDEO CAMERA WITH INTEGRATED VIDEO EFFECTS AND TRANSITIONS

(71) Applicant: LEGRAND AV Inc., Eden Prairie, MN (US)

(72) Inventor: Darrin Thurston, Eden Prairie, MN (US)

(73) Assignee: LEGRAND AV Inc., Eden Prairie, MN (US)

(21) Appl. No.: 16/766,195

(22) PCT Filed: Nov. 21, 2018
(86) PCT No.: PCT/US2018/062270

§ 371 Date: May 21, 2020

Related U.S. Application Data
(60) Provisional application No. 62/589,330, filed on Nov. 21, 2017.

(51) Int. Cl. H04N 5/265; H04N 5/232; H04N 5/262

(52) U.S. Cl. CPC H04N 5/265; H04N 5/23216; H04N 5/2621; H04N 5/23299

(57) ABSTRACT

A pan-tilt-zoom (PTZ) camera providing integrated video mixing capabilities for the PTZ camera video. A PTZ camera includes a sensor control engine to operate at least one sensor to generate unencoded data including unencoded video data, a mixing engine to receive the unencoded video data and generate a composite output including the unencoded video data, a digital graphic, and at least one transition effect, and an input/output engine to transmit the composite output from the PTZ camera. Local video preset transition effects can also be integrated into the video mixing capabilities when a PTZ camera is moved between two locations.

### RELATED APPLICATIONS

This application claims the priority of U.S. Provisional Patent Application No. 62/589,330, filed Nov. 21, 2017, said application being hereby fully incorporated herein by reference.

### TECHNICAL FIELD

Embodiments relate generally to video cameras and, more particularly, to pan-tilt-zoom (PTZ) cameras having integrated video mixing and transition capabilities.

### BACKGROUND

Traditionally, video effects are implemented on an audio/video (AV) switch appliance in which camera images are mixed with digital media sources. As a result, the camera images must be decoded, mixed with graphics, and then re-encoded to create a composite signal (video plus media).

For example, in a live production, a live camera feed is captured by a camera, such as a PTZ camera. The live camera feed is decoded by a production switch. Video production switches are video multiplexers with multiple output buses in which an operator can switch or graphically mix input sources to an output destination. A video production switch may also be referred to as a video switcher, video mixer, or production switcher. Video effects and transitions are then added to the live camera feed with the production video switch. A desired video output is then mixed and re-encoded for output.

Thus, a separate switch is required to add video effects and transitions, adding cost and complexity to a video production system. Further, video images are encoded, decoded, and re-encoded, creating additional cost and inefficiencies during production. There is a need for improved video cameras incorporating integrated video mixing and transition capabilities.

### SUMMARY

Embodiments described herein substantially meet the aforementioned needs of the industry. Video cameras described herein provide integrated video mixing capabilities for the PTZ camera video. Further embodiments can include a local video preset transition effect when a PTZ camera is moved between two locations (presets). Local preset transition effects can provide an enhanced visual experience for on-air camera moves.

In an embodiment, a pan-tilt-zoom (PTZ) camera includes a processor and a memory operably coupled to the processor; at least one sensor configured to record video data, and logic comprising instructions that, when executed, cause the processor to implement: a sensor control engine configured to operate the at least one sensor to generate unencoded data including unencoded video data. A mixing engine is configured to receive the unencoded video data and generate a composite output including the unencoded video data, a digital graphic, and at least one transition effect, and an input/output engine configured to transmit the composite output from the PTZ camera.

In an embodiment, a method for remotely operating a pan-tilt-zoom (PTZ) camera includes providing a PTZ camera including an imager configured to record unencoded video data, and a video mixer engine configured to mix the unencoded video data with a digital graphic, providing a graphical user interface remote from the PTZ camera, the graphical user interface accessible via a network operably coupled to the PTZ camera, receiving, from the graphical user interface, a digital graphic, mixing, with the video mixer engine, the unencoded video data with the digital graphic to generate a composite output, and outputting the composite output from the PTZ camera over the network.

In an embodiment, a pan-tilt-zoom (PTZ) camera system comprises a camera sensor configured to generate unencoded video data and a processor and a memory operably coupled to the processor with logic comprising instructions that, when executed, cause the processor to implement a camera application configured to receive at least one command to control the camera sensor over a network, and a video compositor configured to generate a composite video output by encoding the unencoded video data with at least one media file according to a key layer.

Embodiments allow camera images to be mixed locally with digital media sources. This eliminates the need for a separate AV switch appliance to achieve a desired mixing effect. Cost and complexity are thereby reduced by eliminating this discrete component. Additionally, production cost and inefficiencies are further reduced because there is no longer a need to encode, decode, and re-encode video images.

In a feature and advantage of embodiments, a PTZ camera includes integrated video mixing functions to include static and motion graphic keying internal for camera systems. Further, video transition effects for execution during camera moves from one preset location to next preset location can likewise be included.

In a feature and advantage of embodiments, a PTZ camera is configured for upstream video keying transitions and effects. Upstream keying is a video mix directly associated with a video input and can be present for any video bus transitions. In contrast, downstream keying adds video mix on the output video and is independent of any bus transition. Incorporating upstream keying and transition functions into the camera has significant benefits over typical downstream production systems. For example, end-to-end video delay is improved. Performing upstream video mixing directly at the camera eliminates the need for an input video frame buffer within a production switch, thus reducing the end-to-end video delay (glass-to-glass). In another benefit, upstream keying results in reduced processing requirements, thereby decreasing system throughput.

In a feature and advantage of embodiments, a PTZ camera having integrated video mixing and transition capabilities allows for rich media to be output in a number of video applications, such as conferencing, lecture capture, and live event applications.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a block diagram of a PTZ camera having an integrated mixing engine, according to an embodiment.

FIG. 2 is a block diagram of a mixing engine for a PTZ camera, according to an embodiment.

FIG. 3 is a flowchart of a method for upstream video keying transitions and effects with a PTZ camera, according to an embodiment.

FIG. 4 is a block diagram of a PTZ camera system with a networked user interface, according to an embodiment.

FIG. 5 is a block diagram of a PTZ camera having an integrated compositor and transition effect engine, according to an embodiment.

FIG. 6 is a block diagram of a PTZ camera system, according to an embodiment.

FIG. 7 is a flowchart of a method for a PTZ camera preset transition effect, according to an embodiment.

While various embodiments are amenable to various modifications and alternative forms, specifies thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

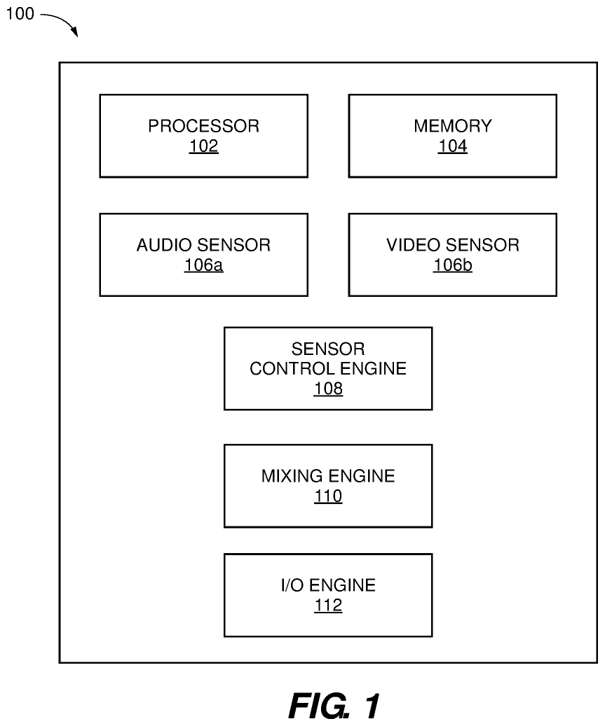

Referring to FIG. 1, a block diagram of a PTZ camera 100 having an integrated mixing engine is depicted, according to an embodiment. PTZ camera 100 generally comprises a processor 102, a memory 104, one or more sensors such as audio sensor 106a and video sensor 106b, a sensor control engine 108, a mixing engine 110, and an I/O engine 112.

The engines described herein can be constructed, programmed, configured, or otherwise adapted, to autonomously carry out a function or set of functions. The term engine as used throughout this document is defined as a real-world device, component, or arrangement of components implemented using hardware, such as by an application specific integrated circuit (ASIC) or field-programmable gate array (FPGA), for example, or as a combination of hardware and software, such as by a microprocessor system and a set of program instructions that cause the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. Accordingly, each engine can be realized in a variety of physically embodied configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly in parallel or series with, and/or complementary to other functions, or distributed differently among a set of engines than specifically illustrated in the examples herein.

Processor 102 can be any programmable device that accepts digital data as input, is configured to process the input according to instructions or algorithms, and provides results as outputs. In an embodiment, the processor(s) discussed herein can be configured to carry out the instructions of a computer program. Processors and other such devices discussed herein are therefore configured to perform basic arithmetical, logical, and input/output operations. Accordingly, processor 102 can implement sensor control engine 108 and mixing engine 110. Processor 102 can further interface with sensors 106 via sensor control engine 108, as will be described.

Memory 104 can comprise volatile or non-volatile memory as required by the coupled processor to not only provide space to execute the instructions or algorithms, but to provide the space to store the instructions themselves. In embodiments, volatile memory can include random access memory (RAM), dynamic random access memory (DRAM), or static random access memory (SRAM), for example. In embodiments, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the invention.

Sensors 106a and 106b comprise audio sensor 106a and video sensor 106b. In an embodiment, audio sensor 106a comprises a sensor that detects and conveys the information that constitutes a sound. For example, audio sensor 106a can comprise a microphone. In an embodiment, video sensor 106b comprises a sensor that detects and conveys the information that constitutes an image. For example, video sensor 106b can comprise an imaging sensor. In embodiments, a single camera sensor can include both sensors 106 for recording audio and video. In other embodiments, PTZ camera 100 can comprise other sensors that can be mixed into audio and video output.

Sensor control engine 108 is configured to interface to sensors 106. In an embodiment, sensor control engine 108 is configured to command audio sensor 106a and/or video sensor 106b to detect a respective signal specific to the sensor. For example, sensor control engine 108 can command audio sensor 106a to record audio signals. Sensor control engine 108 can command video sensor 106b to record video signals. In an embodiment where a single camera sensor includes both sensors 106, a single command can be relayed from sensor control engine 108 to the respective camera.

In an embodiment, sensor control engine 108 is configured to receive sensor data from audio sensor 106a and/or video sensor 106b. For example, a video image can be received from video sensor 106b. Likewise, audio signals accompanying the video image can be received from audio sensor 106a.

In embodiments, sensor control engine 108 can utilize memory 104 to store algorithms for commanding sensors 106. In embodiments, sensor control engine 108 can further utilize memory 104 to store data related to the received video image and audio signals. For example, unencoded video image data can be stored on memory 104. Likewise, raw audio data can be stored on memory 104. In other embodiments, sensor control engine 108 can comprise its own memory discrete from memory 104. In other embodiments, memory 104 is partitioned such that a particular portion is reserved for sensor control engine 108.

Sensor control engine 108 can further communicate video image and audio signal data to mixing engine 110. In an embodiment, video image and audio signal data are stored in non-volatile memory prior to communication to mixing engine 110. In other embodiments, video image and audio signal data are stored in volatile memory and sensor control engine 108 acts as a temporary pass-through to mixing engine 110.

Mixing engine 110 is configured to mix audio and video data with static and motion graphic keying internal to camera system 100. Accordingly, mixing engine 110 is configured to receive unencoded video image and audio signal data from sensor control engine 108. PTZ camera 100 images can therefore be mixed with digital media source data without digital decoding, graphic mixing, and subsequent re-encoding. Rather, a composite signal (video plus media) is generated on camera 100. In further embodiments, mixing engine 110 is configured to mix video transition effects, such as during moves from a first preset location to a second preset location.

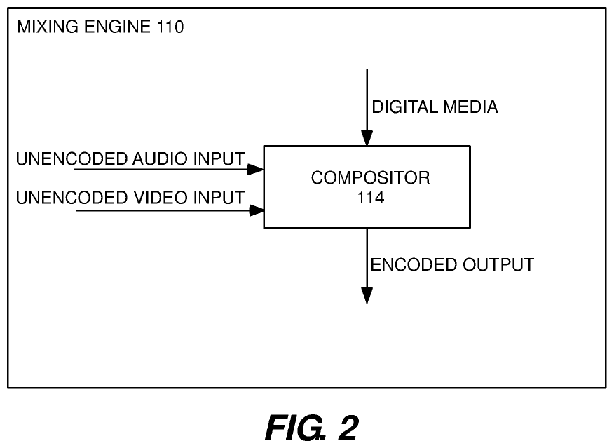

Referring further to FIG. 2, a block diagram of mixing engine 110 is depicted, according to an embodiment. As illustrated, mixing engine 110 comprises a compositor 114.

Compositor 114 is configured to receive unencoded audio and video inputs, as well as digital media inputs, and generate a composite output. In an embodiment, unencoded audio and video inputs can be received internally to PTZ camera 100 from sensor control engine 108. In other embodiments, unencoded audio and video inputs can be received directly from sensors 106. Digital media can be received from a user interface application from a networked user device such as a laptop computer, desktop computer, tablet, or phone via I/O engine 112, as will be described. Compositor 114 can aggregate the received inputs and generate a single output containing data related to all of the inputs. In an embodiment, compositor 114 can comprise macros to execute preconfigured video mixes.

In an embodiment, compositor 114 can further encode the output. For example, compositor 114 can comprise a codec for compressing a generated digital video output. In certain embodiments, the compressed data format can conform to a standard video compression specification. The compression can be lossy by incorporating some data from the unencoded inputs, but not necessarily all.

Referring again to FIG. 1, PTZ camera 100 further comprises I/O engine 112. In embodiments, PTZ camera 100 can comprise networking hardware. I/O engine 112 is configured to operate the networking hardware to transmit and receive network communications. For example, I/O engine 112 can communicate the encoded digital video output to a network or an operably coupled device. In embodiments, I/O engine 112 can receive user commands related to sensor control of sensor control engine 108 and mixing of audio and video data of mixing engine 110.

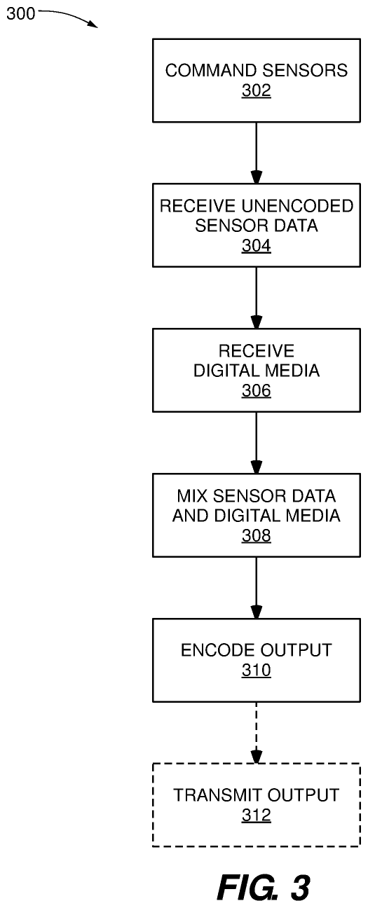

In PTZ camera 100 operation, referring to FIG. 3, a flowchart of a method 300 for upstream video keying transitions and effects is depicted, according to an embodiment. Reference is made throughout the discussion of FIG. 3 to the components of FIGS. 1-2 for context.

At 302, sensors are commanded to record audio and/or video data. For example, sensors 106 can be commanded to record data by sensor control engine 108. Sensor control engine 108 can command audio sensor 106a and video sensor 106b to record a combined audio and video stream. In embodiments, sensor control engine 108 can be operated via I/O engine 112, which receives user input to command sensors 106.

At 304, unencoded sensor data is received from the sensors. In an embodiment, sensor control engine 108 receives raw or unencoded sensor data from audio sensor 106a and video sensor 106b. In an embodiment, the unencoded video and audio data can be stored in memory 104.

At 306, digital media to be incorporated into the sensor data is received. In embodiments, digital media is received via I/O engine 112. The digital media can be stored (either temporarily or more permanently) in memory 104.

At 308, unencoded sensor data is mixed with the digital media to generate a composite output. For example, mixing engine 110 (and more particularly, compositor 114) can access the unencoded sensor data from sensor control engine 108 or via memory 104, as applicable. Further, compositor 114 can access the digital media to be mixed with the sensor data. Compositor 114 then mixes the unencoded sensor data with the digital media.

At 310, the mixed output can be encoded for standardized video compression formats. For example, compositor 114 can encode the composite output after mixing the composite output, or at the same time as the mixing.

Optionally, at 312, the encoded composite video can be transmitted to a network or an operably coupled device. For example, I/O engine 112 can access internal networking hardware to transmit the encoded composite output external to PTZ camera 100 to a viewing device or intermediary device.

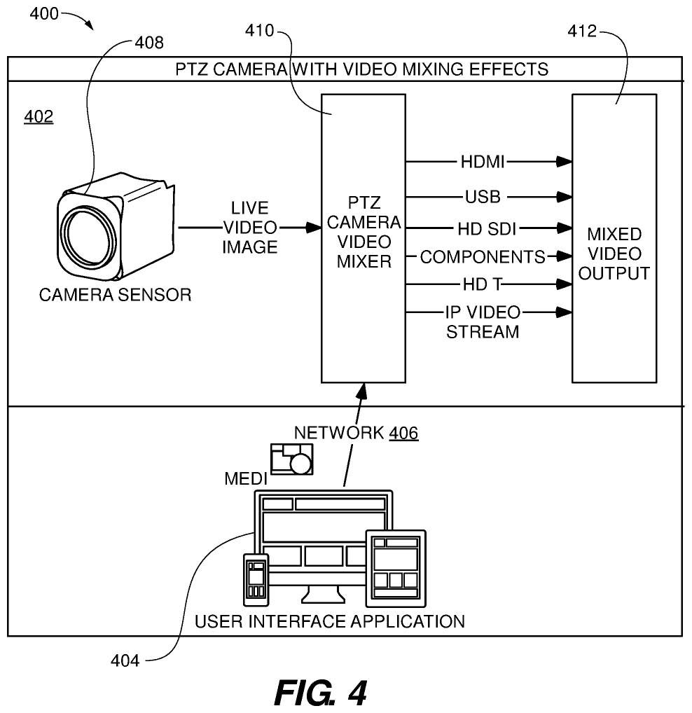

Referring to FIG. 4, a block diagram of a PTZ camera system 400 with a networked user interface is depicted, according to an embodiment. Camera system 400 generally comprises a PTZ camera 402 and a network-accessible user interface 404. As depicted, PTZ camera 402 and user interface 404 are operably coupled by a network 406.

PTZ camera 402 generally comprises a camera sensor 408 and a video mixer engine 410 configured to generate a mixed video output 412.

Camera sensor 408 is configured to record audio and video data at the location of PTZ camera 402. In an embodiment, camera sensor can be substantially similar to audio sensor 106a and video sensor 106b of FIG. 1. Camera sensor 408 is configured to record live video images and communicate the image data to video mixer engine 410.

Video mixer engine 410 is configured to mix live video images and motion graphics files. Accordingly, video mixer engine 410 is further configured to receive live video images from camera sensor 408 and receive motion graphics files from user interface 404. Video mixer engine 410 is configured with a communications interface to receive and transmit to user interface 404. For example, video mixer engine 410 can comprise a web-based server providing access via a web browser.

In an embodiment, video mixer engine 410 is further configured to output a mixed and encoded live video stream 412. Mixed video output engine 412 can output encoded live video stream 412 in any number of formats, including HDMI, USB, HD SDI, composite, HDBT, or IP Video Stream.

PTZ camera 402 is further configured with a local file system to store any motion graphics files received from user interface 404. The local file system includes methods and data structures that the operating system of PTZ camera 402 uses to keep track of files on its memory. In embodiments, the local file system can be partitioned or access-restricted such that interfacing users are provided with only a subset of files stored in memory. In embodiments, the web-based server of video mixer engine 410 can provide access restrictions to the hardware and data of PTZ camera 402.

User interface 404 can comprise a web browser executing on an electronic device. For example, a web browser can operate on a laptop computer, desktop computer, tablet, or phone, as illustrated in FIG. 4. The web browser of user interface 404 can communicate with video mixer engine 410 to transfer motion graphics files to video mixer engine 410. In other embodiments, user interface 404 can be configured to receive data from PTZ camera 402, such as intermediate mixes or final encoded outputs. In other embodiments, user interface 404 can be utilized to provide mixing instructions. For example, user interface 404 can comprise a web browser interface to a third-party website, such as FACEBOOK or YOUTUBE such that mixes can be made directly through those third-party websites without an initial encoding of the video data on PTZ camera 402.

Network 406 operably couples PTZ camera 402 and user interface 404. In an embodiment, network 406 can comprise a standard IP network. In other embodiments, network 406 can comprise a network linking PTZ camera 402 and user interface 404 using proprietary communication protocols. PTZ camera system 400 therefore provides a communications protocol for transferring graphic files and/or motions graphic video clips over an IP network to a PTZ camera.

In PTZ camera system 400 operation, system 400 can implement methods for sending both static and motion graphics files from a user interface 400 device to PTZ camera 402 for video mixing. For example, PTZ camera 402 is commanded by a user of the camera to record video data using camera sensor 408. In embodiments, user interface 404 can be utilized to command camera sensor 408. The live video image captured by camera sensor 408 is made available to video mixer engine 410 either by passing the live video image data to video mixer engine 410 or by passing a memory location of the live video image data to video mixer engine 410.

Concurrently, or after video mixer engine 410 has at least some of the live video image data, a user can access user interface 404 and transfer one or more motion graphics files to video mixer engine 410 over network 406. For example, a web browser running on a user device can be populated by web server content from PTZ camera 402 to prompt the user for the relevant graphics. Once received, video mixer engine 410 can then mix and encode the live video image data with the one or more motion graphics files to create a composite output 412.

Advantageously, the upstream keying of camera system 400 requires only a single decoding operation. This requires less processing than production switching which requires the decoding of video, editing, and then subsequent recoding to be able to send out to a display. Accordingly, no encoding is required between camera sensor 408 and video mixer engine 410.

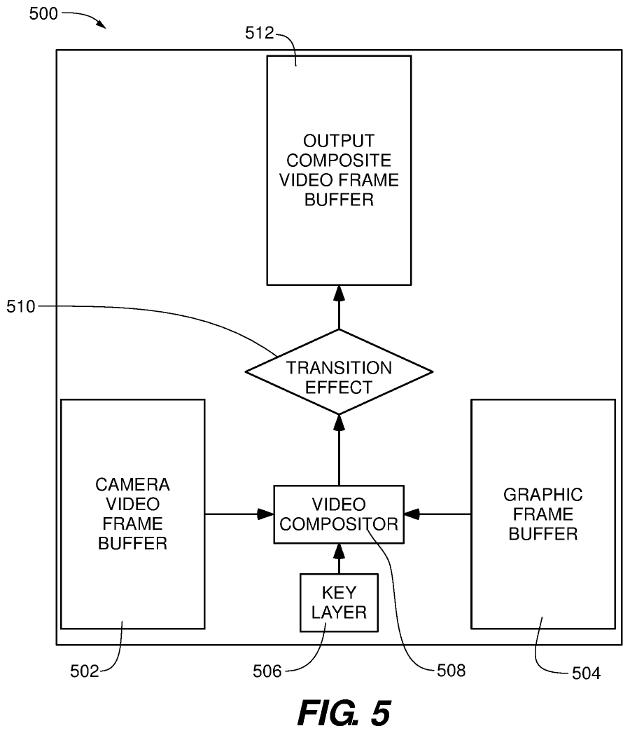

Referring to FIG. 5, a block diagram of a PTZ camera 500 having an integrated compositor and transition effect engine is depicted, according to an embodiment. PTZ camera 500 can implement methods for video mixing and keying of live PTZ camera feed with static or motion graphics. In embodiments, PTZ camera 500 incorporates video mixing and transition functions within the platform of PTZ camera 500.

PTZ camera 500 generally comprises a camera video frame buffer 502, a graphic frame buffer 504, a key layer 506, a video compositor 508, a transition effect 510, and an output composite video frame buffer 512.

Video frame buffer 502 comprises a region of physical memory storage to temporarily store video frame data. For example, video frame buffer 502 can be configured to store data from a camera sensor. Video frame buffer 502 can input video frame data to video compositor 508.

Graphic frame buffer 504 comprises a region of physical memory storage to temporarily store graphic frame data. For example, graphic frame buffer 504 can be configured to store graphic frame data such as digital media to be incorporated with video frame data. Graphic frame data can be stored locally on PTZ camera 500, or can be received from a media source on a coupled network. In certain embodiments, video frame buffer 512 and graphic frame buffer 504 can reside on the same memory, or be partitioned separately in the same memory. Graphic frame buffer 504 can input graphic frame data to video compositor 508.

Key layer 506 comprises layer data for operating on video frame data and/or graphic frame data. For example, key layer 506 can command video compositor 508 to utilize Alpha, Luma, or Chroma keying to integrate video frame data. Other layering or integration techniques can likewise be utilized.

Video compositor 508 can receive inputs from video frame buffer 502, graphic frame buffer 504, and key layer 506 to generate a combined, composite video frame. For example, compositor can integrate graphic frame data from graphic frame buffer 504 and particular video frames from video frame buffer 512 according to key layer 506 data. Video compositor 508 can generate composite video in various standardized formats. Video compositor 508 can be coupled to a transition effect engine.

Transition effect 510 can add various transition effects to the composite video generated by video compositor 508. In embodiments, transition effect 510 can include cuts, dissolves, or wipes. Graphics can be mixed at the native resolution and frame rate of the imager of PTZ camera 500. Subsequently, the composite, effect-supplemented, video can be stored in output composite video frame buffer 512.

Output composite video frame buffer 512 comprises a region of physical memory storage to temporarily store composite, effect-supplemented, video. For example, output composite video frame buffer 512 can be operably coupled to an effects engine such as transition effect 510.

In of PTZ camera 500 operation, video frame data stored in video frame buffer 502, graphic frame data stored in graphic frame buffer 504, and layer data stored in key layer 506 are input to video compositor 508. Video compositor 508 then generates a combined, composite video frame using the inputs. Video compositor 508 passes the composite video frame to transition effect 510 for incorporation of effects into the composite video frame. The resulting output is stored in output composite video frame buffer 512. In certain embodiments, operation on the camera data can be on a single frame, or iteratively frame-by-frame. In other embodiments, operation on the camera data can be done with multiple frames or a stream of frame data.

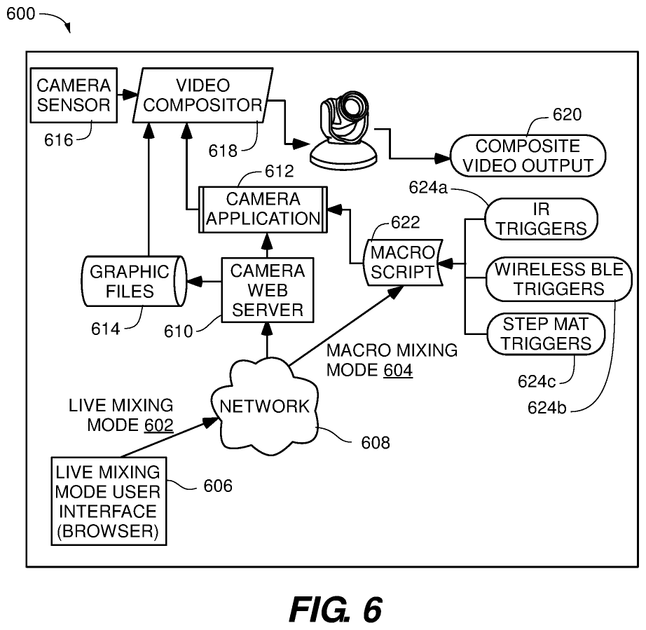

Referring to FIG. 6, a block diagram of a PTZ camera system 600 is depicted, according to an embodiment. PTZ camera system 600 can implement methods for graphic keying to create desired video composites between live camera video and media files. As will be described, engines of PTZ camera system 600 operate using a communication protocol for activating graphic mix functions on a camera over an IP network.

PTZ camera system 600 can implement various modes of operation. A Live Mixing Mode 602 comprises a graphical user interface (browser-based) in which a user can create a desired video composite mix in real-time. A Macro Mixing Mode 604 comprises pre-defined video composite mixing scripts that can be activated with simple trigger inputs to a camera.

Referring first to Live Mixing Mode 602, a user interface 606 is provided via network 608. For example, user interface 606 can access a web server 610 offering web browser access. In Live Mixing Mode 602, a user operating user interface 606 can issue commands via web server 610. Web server 610 can provide access to camera application 612 and graphics files database 614.

In an embodiment, camera application 612 is configured to control the video recording functionality of the camera, such as camera sensor 616. Graphics files database 614 comprises a memory for storing graphics that can be integrated into the camera data. Camera application 612 data and graphics files 614 can be input into a video compositor 618 to generate a composite video output 620.

For example, a user operating user interface 606 can create a desired video composite mix in real-time by commanding camera application 612 to record video data with camera sensor 616. The user can further access web server 610 to upload a set of graphics files to graphics files database 614. In other embodiments, the user accesses pre-defined graphics files on graphics files database 614. Video compositor 618 receives data from camera sensor 616 and the selected graphics files from graphics files database 614 and generates a composite video output 620.

Referring next to Macro Mixing Mode 604, a macro script 622 comprises a pre-defined video composite mixing script that can be activated with simple trigger inputs to camera application 612. Infrared (IR) triggers 624a, wireless BLUETOOTH Low Energy (BLE) triggers 624b, and/or step mat triggers 624c can activate macro script 622. For example, if an IR device is sensed by 1R trigger 624a, a corresponding macro script 622 for the IR device can be activated. Corresponding commands can be input into camera application 612 to use the JR device and particular mixing by video compositor 618. Likewise, if a BLE device is sensed by BLE trigger 624b, the corresponding macro script 622 for the BLE device can be activated. Corresponding commands can be input into camera application 612 to use the BLE device and particular mixing by video compositor 618. Similarly, if a step mat is sensed by step mat trigger 624c, the corresponding macro script 622 for the step mat device can be activated. Corresponding commands can be input into camera application 612 to use the step mat device and particular mixing by video compositor 618.

Accordingly, video compositor 618 receives data from camera sensor 616 and macro script 622 and generates a composite video output 620. Macro script 622 can draw appropriate graphics files from graphics files database 614 into video compositor 618 to be used in generating composite video output 620.

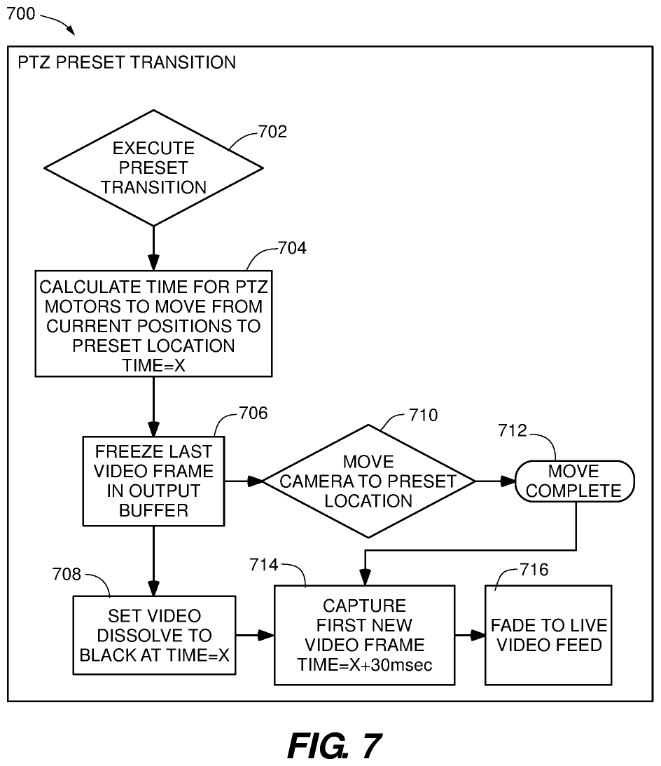

Referring to FIG. 7, a flowchart of a method 700 for a PTZ camera preset transition effect is depicted, according to an embodiment. Method 700 can calculate the time to move a PTZ camera from point A to point B and apply a video transition effect during the move time to enhance visual presentation of live video. Tri-synchronous pan/tilt/zoom motion operations are incorporated into the video transition effect.

For example, in an embodiment, a PTZ camera has tri-synchronous motion capability that time aligns pan, tilt, and zoom operations to arrive simultaneously from a current location to a new location. Algorithms calculating arrival time are used to actuate a video transition effect on the PTZ camera. Specifically, a transition time is calculated between point A and point B which is coincident with camera movement time. A video transition effect is executed during the transition time. In an embodiment, the effect is video freeze frame, dip-to-black, and fade back to live video. In other embodiments, other effects can similarly be utilized.

At 702, a preset transition function is entered. For example, a preset transition function can be executed by a mixing engine or an effects engine.

At 704, a time calculation is conducted. In an embodiment, the time for PTZ motors to move the camera from a first (current) position to a second (preset) position is calculated as time X, as depicted in FIG. 7.

At 706, the last video frame is frozen and saved in an output buffer. In an embodiment, the last video frame is the last video data shown before the transition effect.

At 708, the video dissolve is set to black for a duration of time X. During time X, the image shown is the transition to black.

Likewise, from 706, at 710, the PTZ camera is moved to a second (preset) position from the first (current) position.

At 712, time has passed and the PTZ camera move to the second position is complete.

At 714, a first new video frame is captured at time=X+30 ms by the PTZ camera at the second position.

At 716, the video is faded back into a live video feed of video frames captured at the second position, having shown a video effect during the transition time between the first position and the second position.

In another embodiment, a method implements a video transition based on an estimated IP network switching delay for video over an IP stream from a PTZ camera. For example, a PTZ camera can calculate a video transition time for the PTZ camera outputting video over IP (SMPTE 2110 or similar) on a standard network by using an estimated IP switching delay on a layer 3 network.

In an embodiment, an estimation algorithm utilizes the number of network hops between the camera and a decoding appliance. For example, an average switching delay on the physical network can be applied. In embodiments, the estimation algorithm further utilizes video compression frame delay, which estimates the video compression delay on the camera based upon compression type. For example, compression types such as Tico, VC2, H.264, and H.265 all add to the overall delay, but can vary in respective processing times.

A calculated total network delay is used as video transition time between two or more PTZ cameras with video effect capabilities. A video transition effect is executed during network switching time between the two cameras. In an embodiment, the effect is video freeze frame, dip-to-black, and fade to live video.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 114(f) are not to be invoked unless the specific terms “means for” or “step for” are recited in a claim.

1. A pan-tilt-zoom (PTZ) camera comprising:
a processor and a memory operably coupled to the processor;
at least one sensor configured to record video data; and
logic comprising instructions that, when executed, cause the processor to implement:
a sensor control engine configured to operate the at least one sensor to generate unencoded data including unencoded video data,
a mixing engine configured to receive the unencoded video data and generate a composite output including the unencoded video data, a digital graphic, and at least one transition effect, and
an input/output engine configured to transmit the composite output from the PTZ camera.

2. The PTZ camera of claim 1, further comprising an audio sensor configured to record audio data, wherein the sensor control engine is further configured to operate the audio sensor to generate unencoded data including unencoded audio data, and wherein the mixing engine is further configured to receive the unencoded audio data and generate the composite output by including the unencoded audio data in the composite output.

3. The PTZ camera of claim 1, wherein the mixing engine comprises a compositor configured to aggregate the unencoded data with the digital graphic and the at least one transition effect and encode the composite output.

4. The PTZ camera of claim 3, wherein the compositor comprises a codec for compressing the generated composite output.

5. The PTZ camera of claim 1, further comprising a graphical user interface presented through a network.

6. The PTZ camera of claim 5, wherein the memory comprises a local file system configured to store the digital graphic received through the graphical user interface.

7. The PTZ camera of one of claim 1, wherein the memory further comprises:
a camera video frame buffer configured to temporarily store the unencoded video data;
a graphic frame buffer configured to temporarily store the digital graphic; and
an output composite video frame buffer configured to temporarily store the composite output,
wherein the mixing engine comprises:
a key layer configured with layer integration data for the unencoded video data and the digital graphic;
a compositor configured to:
access the camera video frame buffer and the graphic frame buffer,
integrate the unencoded video data and the digital graphic according to the layer data as the composite output,
add the at least one transition effect to the composite output, and
store the composite output in the output composite video frame buffer.

8. The PTZ camera of claim 1, wherein the at least one transition effect is predefined when the PTZ camera is moved between a first preset location and a second preset location.

9. The PTZ camera of claim 8, further comprising a motor configured to move the PTZ camera from the first preset location to the second preset location, wherein the mixing engine comprises instructions to calculate a transition time for the motor to move the PTZ camera between the first and second preset locations, and wherein the at least one transition effect is applied during the transition time by:
displaying a first preset location video frame captured at the first preset location;
displaying the at least one transition effect; and
displaying a second present location video frame captured at the second preset location.

10. The PTZ camera of claim 1, wherein the mixing engine comprises instructions to calculate a transition time for a network switching delay between the PTZ camera and a second PTZ camera, and wherein the at least one transition effect is applied during the transition time by displaying:
a first preset location video frame captured at a first preset location by the PTZ camera;
the at least one transition effect; and
a second present location video frame captured at a second preset location by the second PTZ camera.

11. A method for remotely operating a pan-tilt-zoom (PTZ) camera, the method comprising:
providing a PTZ camera including:
an imager configured to record unencoded video data, and
a video mixer engine configured to mix the unencoded video data with a digital graphic;
providing a graphical user interface remote from the PTZ camera, the graphical user interface accessible via a network operably coupled to the PTZ camera;
receiving, from the graphical user interface, a digital graphic;
mixing, with the video mixer engine, the unencoded video data with the digital graphic to generate a composite output; and
outputting the composite output from the PTZ camera over the network.

12. The method for remotely operating the PTZ camera of claim 11, wherein the video mixer engine comprises a compositor and the mixing further comprises aggregating, with the compositor, the unencoded video data with the digital graphic and at least one transition effect and encoding, with the compositor, the composite output.

13. The method for remotely operating the PTZ camera of claim 11, wherein the PTZ camera further comprises a memory comprising a local file system, wherein the method further comprises storing, in the local file system, the digital graphic received from the graphical user interface.

14. The method for remotely operating the PTZ camera of claim 11, wherein the PTZ camera further comprises a memory including a camera video frame buffer configured to store the unencoded video data, a graphic frame buffer configured to store the digital graphic, and an output composite video frame buffer configured to store the composite output, wherein the method further comprises:
temporarily storing the unencoded video data in the camera video frame buffer;
temporarily storing the digital graphic in the graphic frame buffer;
integrating the unencoded video data and the digital graphic according to layer integration data as the composite output; and
adding at least one transition effect to the composite output.

15. The method for remotely operating the PTZ camera of claim 11, wherein the PTZ camera further includes a motor configured to move the PTZ camera from a first preset location to a second preset location, the method further comprising:
adding at least one transition effect to the composite output prior to outputting the composite output from the PTZ camera by:
calculating a transition time for the motor to move the PTZ camera between the first and second preset locations,
displaying a first preset location video frame captured at the first preset location,
displaying the at least one transition effect, and
displaying a second present location video frame captured at the second preset location.

16. The method for remotely operating the PTZ camera of claim 11, further comprising:
adding at least one transition effect to the composite output prior to outputting the composite output from the PTZ camera by:
calculating a transition time for a network switching delay between the PTZ camera and a second PTZ camera,
displaying a first preset location video frame captured at a first preset location by the PTZ camera,
displaying the at least one transition effect; and
displaying a second present location video frame captured at a second preset location by the second PTZ camera.

17. A pan-tilt-zoom (PTZ) camera system comprising:
a camera sensor configured to generate unencoded video data; and
a processor and a memory operably coupled to the processor and logic comprising instructions that, when executed, cause the processor to implement:
a camera application configured to receive at least one command to control the camera sensor over a network, and
a video compositor configured to generate a composite video output by encoding the unencoded video data with at least one media file according to a key layer.

18. The PTZ camera system of claim 17, further comprising a camera web server presenting a graphical user interface accessible over the network and operably coupled to the camera application to input, in real-time, the at least one command to control the camera sensor, the at least one media file, and the key layer.

19. The PTZ camera system of claim 17, further comprising a macro script operably coupled to the camera application with a predefined selection of the at least one command to control the camera sensor, the at least one media file, and the key layer.

20. The PTZ camera system of claim 19, wherein the macro script is activated as input to the camera application by a physical trigger related to the PTZ camera, and wherein the macro script is specific to the physical trigger.
